(19) United States
(12) Patent Application Publication
(10) Pub. No.: US 2018/0350280 A1
(43) Pub. Date: Dec. 6, 2018

(54) MOBILE ADVERTISEMENT VEHICLE

(71) Applicant: Edward Poole, Grayson, GA (US)

(72) Inventor: Edward Poole, Grayson, GA (US)

(21) Appl. No.: 15/995,108

(22) Filed: May 31, 2018

Related U.S. Application Data
(60) Provisional application No. 62/512,823, filed on May 31, 2017.

(51) Int. Cl. G09F 21/04

(52) U.S. Cl. CPC G09F 21/048

(57) ABSTRACT

Implementations of a mobile advertisement vehicle system are provided. In some implementations, the mobile advertisement vehicle system comprises a viewing assembly and a decorative overlay or trim configured to install on a van or other vehicle and configured to display text, graphics, still or moving images, and/or other video output outside of the vehicle. In some implementations, the mobile advertisement vehicle system further comprises additional components such as one or more audio speakers, power sources, and/or surveillance cameras.

### CROSS REFERENCE TO RELATED APPLICATION

This application claims the benefit of U.S. Patent Application Ser. No. 62/512,823, which was filed on May 31, 2017, and is incorporated herein by reference in its entirety.

### TECHNICAL FIELD

This disclosure relates to implementations of a mobile advertisement vehicle system.

### BACKGROUND

Vans or other vehicles are a popular form of transportation that provide nearly unlimited mobility in most environments. Advertisements or other graphical displays such as text, graphics, images, or video are popular communications mediums for nearly any purpose or topic.

### BRIEF DESCRIPTION OF THE DRAWINGS

FIG. 1 illustrates an implementation of an example mobile advertisement vehicle system according to the present disclosure.

FIGS. 2A and 2B illustrate an example cross section view of the mobile advertisement vehicle system shown in FIG. 1.

FIG. 3 illustrates an implementation of an example display assembly of the mobile advertisement vehicle system shown in FIG. 1.

### DETAILED DESCRIPTION

Implementations of a mobile advertisement vehicle system are provided. In some implementations, the mobile advertisement vehicle system comprises a viewing assembly and a decorative overlay or trim configured to install on a van or other vehicle and configured to externally display text, graphics, still or moving images, and/or any other suitable video output outside of the vehicle.

In some implementations, the mobile advertisement vehicle system further comprises additional components such as one or more audio speakers, power sources, and/or surveillance cameras.

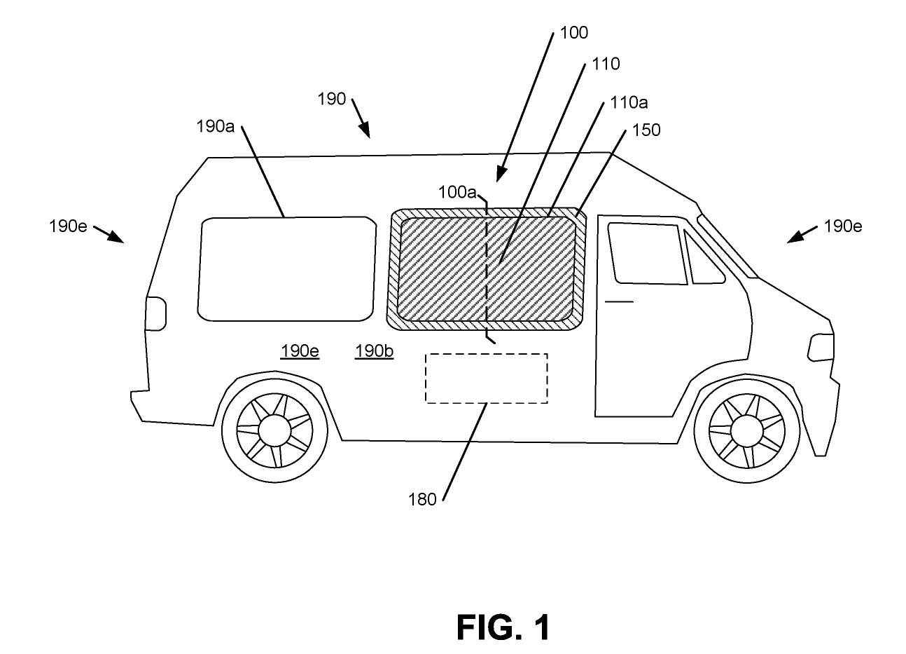

FIG. 1 illustrates an implementation of an example mobile advertisement vehicle system 100 according to the present disclosure.

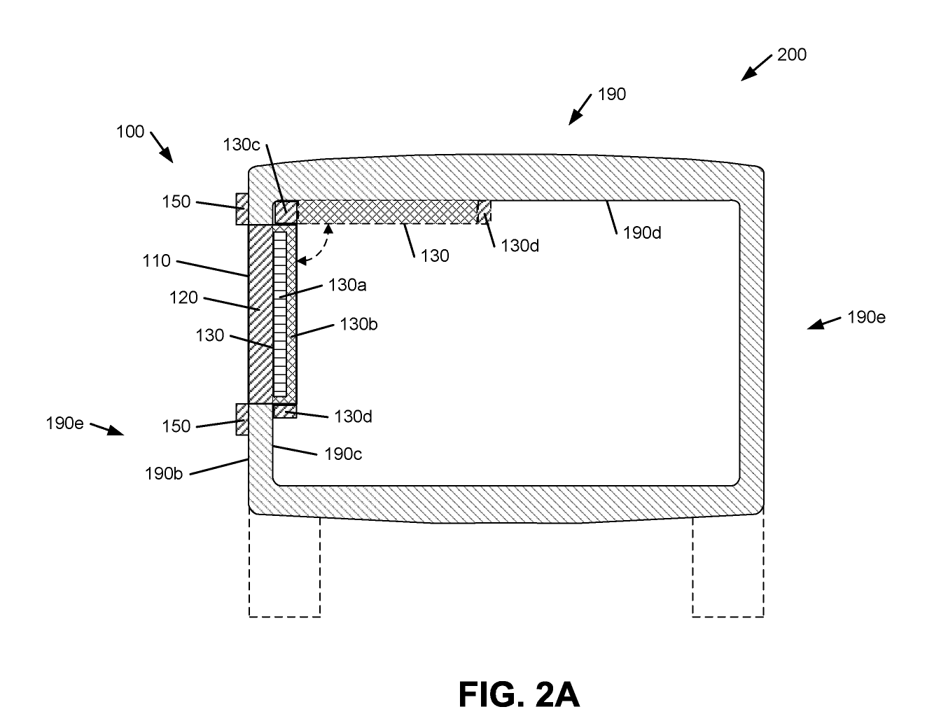

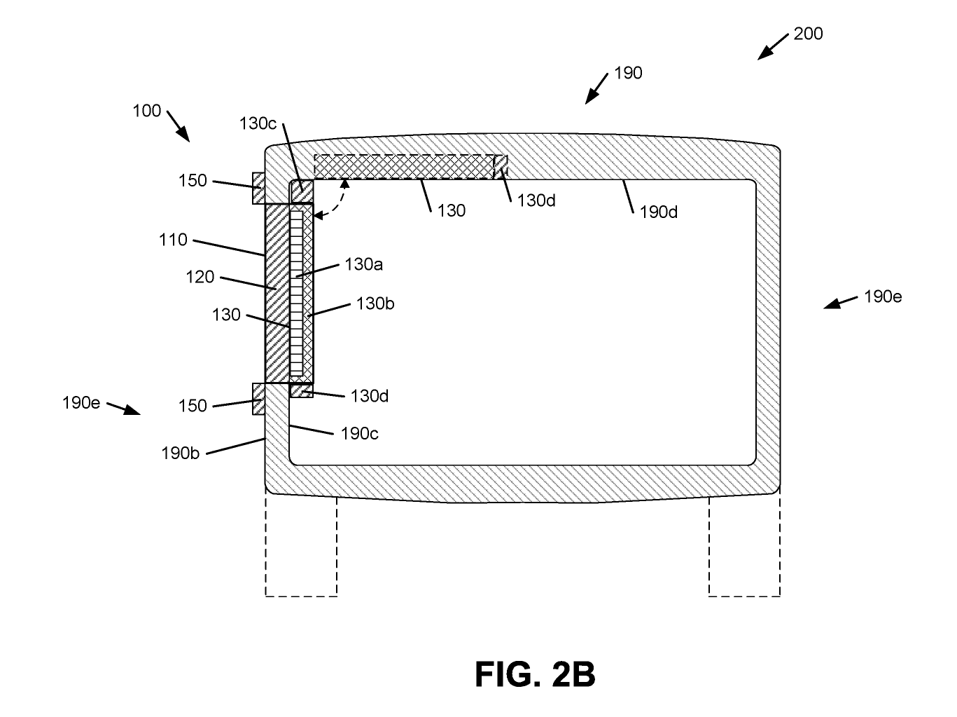

FIGS. 2A and 2B illustrate an example cross section view 200 of the mobile advertisement vehicle system 100 shown in FIG. 1.

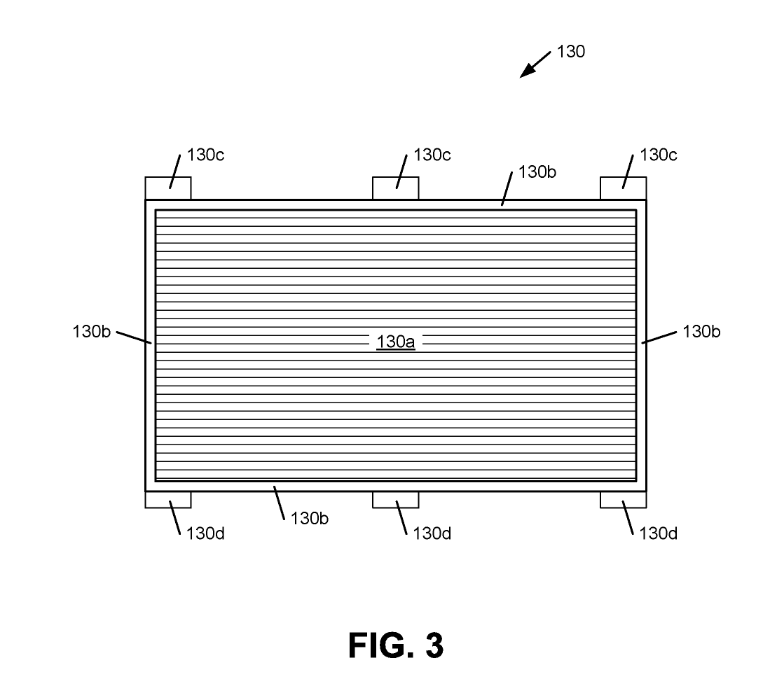

FIG. 3 illustrates an implementation of an example display assembly 130 of the mobile advertisement vehicle system 100 shown in FIG. 1.

In some implementations, as shown for example in FIGS. 1 and 2, the mobile advertisement vehicle system 100 includes a viewing assembly 110.

In some implementations, as shown for example in FIGS. 1 and 2, the mobile advertisement vehicle system 100 also includes a decorative overlay or trim 150.

In some implementations, as shown for example in FIG. 1, the mobile advertisement vehicle system 100 further includes additional components 180.

In some implementations, as shown for example in FIGS. 1 and 2, the mobile advertisement vehicle system 100 is installed on a van or other vehicle 190.

In some implementations, the mobile advertisement vehicle system 100 is powered by the power supply of the van 190. In some implementations, the mobile advertisement vehicle system 100 is powered by an additional power generator included with the additional components 180. In some implementations, the mobile advertisement vehicle system 100 is powered by any other suitable power source.

In some implementations, the viewing assembly 110 is installed in addition to or replacement of a window 190a of the van 190. In some implementations, a plurality of viewing assemblies 110 are installed in addition to or replacement of a plurality of windows 190a of the van 190.

In some implementations, the viewing assembly 110 is installed on one or more sides 190e of the van 190, such as the passenger side and/or the driver side of the van 190. In some implementations, the viewing assembly 110 is installed in any other suitable location on the van 190.

In some implementations, as shown for example in FIGS. 2A and 2B (collectively FIG. 2), the viewing assembly 110 includes a window assembly 120 and a display assembly 130.

In some implementations, the window assembly 120 includes one or more layers of clear material that replaces the glass or other clear material of the window 190a of the van 190.

In some implementations, the window assembly 120 is comprised of the glass or other clear material that comprises the window 190a of the van 190.

In some implementations, the window assembly 120 includes one or more layers of clear material in addition to the glass or other clear material that comprises the window 190a of the van 190.

In some implementations, the window assembly 120 includes one or more layers of glass or a glass material.

In some implementations, the window assembly 120 includes one or more layers of an acrylic or an acrylic glass material such as Plexiglas.

In some implementations, the window assembly 120 includes one or more layers of any other suitable clear material.

In some implementations, the window assembly 120 is installed within one or more exterior and/or interior gaskets or seals of the window 190a of the van 190.

In some implementations, as shown for example in FIGS. 2 and 3, the display assembly 130 includes a video display or monitor 130a, a frame 130b, a hinge mechanism 130c, and an attachment mechanism 130d.

In some implementations, the display assembly 130 positions flush to an interior panel 190c of the van 190 for usage. In some implementations, the display assembly 130 alternately positions adjacent to or within a roof panel 190d of the van 190 for storage. In some implementations, the display assembly 130 positions in any other suitable position or location in the van 190.

In some implementations, the display 130a can be any type of video display or monitor suitable to display text, graphics, still or moving images, or any other suitable video output. In some implementations, such text, graphics, images, or other suitable video output may include messages, announcements, pictures, or movies.

In some implementations, the display 130a is a digital display. In some implementations, the display 130a is a high-definition display. In some implementations, the display 130a is an LED display. In some implementations, the display 130a is a flexible screen. In some implementations, the display 130a is any other suitable type of display.

In some implementations, the display 130a is configured to display advertisements. In some implementations, such advertisements can be one or more still-shots that fade in and fade out. In some implementations, such advertisements can be one or more still-shots that are displayed in any other suitable manner.

In some implementations, the display 130a is configured to display news information. In some implementations, the display 130a is configured to display traffic information. In some implementations, the display 130a is configured to display weather information. In some implementations, the display 130a is configured to display any other suitable information.

In some implementations, the display 130a is configured to display a public service announcement. In some implementations, such public service announcement can be a missing child alert such as an amber alert. In some implementations, such public service announcement can be a be-on-the-lookout alert. In some implementations, such public service announcement can be any other suitable public service announcement.

In some implementations, the display 130a is configured to display a personal announcement. In some implementations, such personal announcement can be a birthday announcement. In some implementations, such personal announcement can be an anniversary announcement. In some implementations, such personal announcement can be any other suitable personal announcement.

In some implementations, the display 130a is configured to dim or brighten to adjust for visibility in surrounding light levels. In some implementations, the display 130a is configured to make any other suitable adjustment for visibility.

In some implementations, the frame 130b holds the display 130a. In some implementations, the frame 130b is configured to position the display 130a so that it is viewable through the window assembly 120 when the display assembly 130 is in use.

In some implementations, the frame 130b positions adjacent to the interior panel 190c of the van 190 when the display assembly 130 is in use.

In some implementations, the frame 130b positions the display 130a adjacent to or within a roof panel 190d of the van 190 when the display assembly 130 is not in use.

In some implementations, the frame 130b positions the display 130a in any other suitable position when the display assembly 130 is in use or not in use.

In some implementations, the hinge mechanism 130c is attached to the frame 130b and to the roof panel 190d or an interior panel 190c of the van 190.

In some implementations, the hinge mechanism 130c supports the display assembly 130 in a position so the display 130a is viewable through the window assembly 120.

In some implementations, the hinge mechanism 130c supports the display assembly 130 in a position adjacent to (for example as shown in FIG. 2A) or within a roof panel 190d (for example as shown in FIG. 2B) of the van 190. In some implementations, the hinge mechanism 130c supports the display assembly 130 in any other suitable position or location in the van 190.

In some implementations, the hinge mechanism 130c is any suitable mechanism that can support the display assembly 130 in any suitable position or location in the van 190. One of ordinary skill in the art with the benefit of this disclosure would know how to make a hinge having the above-described functionality. Any existing or future-developed hinge is envisioned for this disclosure.

In some implementations, the attachment mechanism 130d is attached to the frame 130b.

In some implementations, the attachment mechanism 130d is configured to attach to an interior panel 190c of the van 190 to keep the display assembly 130 in a position so the display 130a is viewable through the window assembly 120. In some implementations, a separate device is attached to the interior panel 190c and mates with the attachment mechanism 130d.

In some implementations, the attachment mechanism 130d is configured to attach to a roof panel 190d of the van 190 to keep the display assembly 130 in a position adjacent to or within the roof panel 190d. In some implementations, a separate device is attached to the roof panel 190d and mates with the attachment mechanism 130d.

In some implementations, the attachment mechanism 130d is any suitable mechanism that can attach to the display assembly 130a and to an interior panel 190c or a roof panel 190d of the van 190 to keep the display assembly 130 in a suitable position or location in the van 190.

One of ordinary skill in the art with the benefit of this disclosure would know how to make an attachment mechanism 130d and corresponding device for the vehicle panel 190c, 190d having the above-described functionality. Any existing or future-developed attachment mechanism 130d and corresponding device is envisioned for this disclosure.

In some implementations, as shown for example in FIGS. 1 and 2, the decorative overlay 150 is installed on an exterior surface 190b of the van 190.

In some implementations, the decorative overlay 150 is installed around the perimeter or edge 110a of the viewing assembly 110. In some implementations, the decorative overlay 150 is installed over the viewing assembly 110.

In some implementations, the decorative overlay 150 is attached to the exterior surface 190b of the van 190 by an adhesive. In some implementations, the decorative overlay 150 is attached to the exterior surface 190b of the van 190 by screws or rivets. In some implementations, the decorative overlay 150 is attached to the exterior surface 190b of the van 190 by any other suitable way of attachment.

In some implementations, the decorative overlay 150 comprises multiple layers of one or more materials.

In some implementations, the decorative overlay 150 is comprised of a plastic. In some implementations, the decorative overlay 150 is comprised of a metal. In some implementations, the decorative overlay 150 is comprised of any other suitable material.

In some implementations, the decorative overlay 150 is fluorescent. In some implementations, the decorative overlay 150 has any other suitable appearance feature.

In some implementations, as shown for example in FIG. 1, the additional components 180 are installed near or adjacent to the viewing assembly 110 and/or decorative overlay 150.

In some implementations, the additional components 180 are installed on an exterior surface 190b of the van 190. In some implementations, the additional components 180 are installed in other locations on or inside of the van.

In some implementations, the additional components 180 are installed on one or more sides 190e of the van 190. In some implementations, the additional components 180 are installed in any other suitable location on the van 190.

In some implementations, the additional components 180 include one or more components.

In some implementations, the additional components 180 include one or more audio speakers. In some implementations, such audio speakers are configured to operate in conjunction with the display 130a. In some implementations, such audio speakers are configured to operate in any other suitable manner.

In some implementations, the additional components 180 include one or more power sources, such as a battery or generator. In some implementations, such power sources are configured to power one or more components of the mobile advertisement vehicle system 100.

In some implementations, the additional components 180 include one or more surveillance cameras. In some implementations, such surveillance cameras are configured to monitor the security of one or more components of the mobile advertisement vehicle system 100. In some implementations, such surveillance cameras are configured to monitor any other activity in, on, or adjacent to the van 190. In some implementations, the video display 130a is configured to display the video or images captured by the surveillance cameras.

In some implementations, the additional components 180 include any other suitable component related to the mobile advertisement vehicle system 100.

The figures, including photographs and drawings, comprised herewith may represent one or more implementations of the mobile advertisement vehicle system.

Details shown in the figures, such as dimensions, descriptions, etc., are exemplary, and there may be implementations of other suitable details according to the present disclosure.

Reference throughout this specification to “an embodiment” or “implementation” or words of similar import means that a particular described feature, structure, or characteristic is comprised in at least one embodiment of the present invention. Thus, the phrase “in some implementations” or a phrase of similar import in various places throughout this specification does not necessarily refer to the same embodiment.

Many modifications and other embodiments of the inventions set forth herein will come to mind to one skilled in the art to which these inventions pertain having the benefit of the teachings presented in the foregoing descriptions and the associated drawings.

The described features, structures, or characteristics may be combined in any suitable manner in one or more embodiments. In the above description, numerous specific details are provided for a thorough understanding of embodiments of the invention. One skilled in the relevant art will recognize, however, that embodiments of the invention can be practiced without one or more of the specific details, or with other methods, components, materials, etc. In other instances, well-known structures, materials, or operations may not be shown or described in detail.

While operations may be depicted in the drawings in a particular order, this should not be understood as requiring that such operations be performed in the particular order shown or in sequential order, or that all illustrated operations be performed, to achieve desirable results.

1. A mobile advertisement vehicle system comprising a viewing assembly and a decorative overlay, wherein:
the viewing assembly is configured to be installed on a vehicle;
the viewing assembly is configured to display outside of the vehicle at least one of text, graphics, still images, moving images, or video; and
the decorative overlay is configured to be installed on the vehicle adjacent to the viewing assembly to provide a decorative appearance to the viewing assembly.

2. The mobile advertisement vehicle system of claim 1 further comprising at least one of an audio speaker, a powers source, or a surveillance camera.
